(19) United States
(12) Patent Application Publication
(10) Pub. No.: US 2026/0365071 A1
(43) Pub. Date: Nov. 19, 2026

(54) SYSTEM AND METHOD FOR CHARGING A FLEET OF ELECTRIC RESOURCES

(71) Applicant: Electric Era Technologies Inc., Seattle, WA (US)

(72) Inventors: Quincy Lee, Seattle, WA (US); Hasitha Dharmasiri, Seattle, WA (US)

(21) Appl. No.: 19/210,656

(22) Filed: May 16, 2025

(51) Int. Cl. B60L 53/67; B60L 53/53; B60L 53/62; B60L 53/63

(52) U.S. Cl. CPC B60L 53/67; B60L 53/53; B60L 53/62; B60L 53/63

(57) ABSTRACT

A method for charging electric resources includes receiving one or more jobs to be performed by a fleet of electric resources during a given period, with each resource having a battery. The method further includes determining a requested load associated with charging the fleet at a charging station during the given period based at least in part on a state of charge of the battery of each resource and the one or more jobs to be performed. Moreover, the method includes determining one or more charging parameters based at least in part on the requested load and at least one of a defined value for the grid or a charge level of the battery energy storage system during the given period. Additionally, the method includes generating one or more commands for one or both of the fleet or the charging station based on the one or more charging parameters.

### FIELD OF THE INVENTION

The present disclosure generally relates to charging systems, which may be implemented at one or more remote sites (or access locations) for charging electric resources, such as a fleet of mobile units, such as a fleet of robots.

### BACKGROUND OF THE INVENTION

Some electric resources, such as robots, can perform work automatically and rely on their own power and control capabilities to achieve various functions. Robots can be commanded by humans, run according to pre-arranged programs, and/or act autonomously according to the principles and programs formulated by artificial intelligence technology. Depending on the functions being performed, robots may require a large amount of power to operate. For instance, autonomous robots may particularly require a large amount of power to operate. For example, the power load of an autonomous robot is currently between about 0.5 kilowatts per hour (kW/h) and about 3.75 kW/h depending on use. As such, a fleet of robots within a facility may cause the power demand of the facility to be large. Moreover, the time for charging each of the robots may be significant, and the downtime while charging is not ideal. Additionally, utility companies determine how to allocate energy resources based on continuously varied supply and demand. As a result, charging systems for fleets of such robots may be limited in power, leading to varied charging rates and costs. Thus, systems and related methods that can increase the efficiency of charging fleets of electric resources, such as robots, would be welcomed by the industry.

### SUMMARY OF THE INVENTION

Aspects and advantages of the invention will be set forth in part in the following description, may be obvious from the description, or may be learned through practice of the invention.

According to some aspects of the present disclosure, a system for charging electric resources may include a fleet of electric resources, where each resource of the fleet of electric resources may have a battery. The system may further include a charging station, where each resource of the fleet of electric resources may be selectively coupled to the charging station for charging, and where the charging station may be configured to supply power from at least one of a grid or a battery energy storage system during charging. Additionally, the system may include a computing system including a processor and associated memory. The memory may store instructions that, when implemented by the processor, may configure the computing system to receive one or more jobs to be performed by the fleet during a given period. The computing system may further be configured to determine a requested load associated with charging the fleet of electric resources during the given period based at least in part on a state of charge of the battery of each resource of the fleet of electric resources and the one or more jobs to be performed. Moreover, the computing system may be configured to determine one or more charging parameters based at least in part on the requested load and at least one of a defined value for the grid or a charge level of the battery energy storage system during the given period. Additionally, the computing system may be configured to generate one or more commands for one or both of the fleet of electric resources or the charging station based at least in part on the one or more charging parameters.

According to some aspects of the present disclosure, a method for charging electric resources may include receiving one or more jobs to be performed by a fleet of electric resources during a given period, where each resource of the fleet of electric resources may have a battery. The method may further include determining a requested load associated with charging the fleet of electric resources at a charging station during the given period based at least in part on a state of charge of the battery of each resource of the fleet of electric resources and the one or more jobs to be performed, where each resource of the fleet of electric resources may be selectively coupled to the charging station for charging, and where the charging station may be configured to supply power from at least one of a grid or a battery energy storage system during charging. Moreover, the method may include determining one or more charging parameters based at least in part on the requested load and at least one of a defined value for the grid or a charge level of the battery energy storage system during the given period. Additionally, the method may include generating one or more commands for one or both of the fleet of electric resources or the charging station based at least in part on the one or more charging parameters.

These and other features, aspects, and advantages of the present technology will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a schematic view of a system for charging a robot fleet according to some aspects of the present disclosure;

FIG. 2 is a block diagram illustrating components of the system of FIG. 1 operably coupled with a remote server in accordance with aspects of the present subject matter;

FIG. 3 is a schematic block diagram illustrating portions of the system of FIG. 1 in accordance with aspects of the present subject matter;

FIG. 4 illustrates a schematic view of a flow diagram for training a machine-learned model in accordance with aspects of the present subject matter;

FIG. 5 is a schematic diagram of communications of the system of FIG. 1 in accordance with aspects of the present disclosure; and

FIG. 6 is a method for charging a fleet of robots in accordance with aspects of the present disclosure.

Repeat use of reference characters in the present specification and drawings is intended to represent the same or analogous features or elements of the present technology.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify a location or importance of the individual components. Moreover, for purposes of convenience and clarity only, directional terms, such as top, bottom, left, right, up, down, over, above, below, beneath, rear, back, and front, may be used with respect to the accompanying drawings. These and similar directional terms should not be construed to limit the scope of the disclosure in any manner. Thus, it will be appreciated that the apparatus and/or any component described here may be oriented in one or more orientations that are rotationally offset from those illustrated without departing from the scope of the present disclosure.

The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to electrical power flow through a system. For example, “upstream” refers to the direction from which the electrical power flows, and “downstream” refers to the direction in which the electrical power flows. The term “selectively” refers to a component's ability to operate in various states (e.g., an ON state and an OFF state) based on manual and/or automatic control of a component.

The singular forms “a,” “an,” and “the” include plural references unless the context clearly dictates otherwise. In addition, the term “each” may be used interchangeably with “any” for any feature described herein.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

Here and throughout the specification and claims, range limitations are combined, and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and related methods for charging electric resources, such as a fleet of robots. A charging network includes one or more charging systems that may be implemented at one or more remote sites or locations for charging services at a facility. In several examples, each charging system may be configured to be electrically coupled with a power source, such as a grid, to provide power to the charging system. However, the power source may be any other type of power source that provides electrical power to one or more of the charging systems, such as solar power, wind-generated power, and/or any other manner of generating power.

In various examples, each charging system can include a grid interconnect that is electrically couplable to the power source. A battery energy storage system may be electrically coupled with the grid interconnect. In addition, one or more charging stations at a facility may be electrically coupled with the grid interconnect and the battery energy storage system in parallel. Each charging station is configured to selectively transfer power therefrom to an electrical resource, such as a robot. Although electrical energy and electrical power are not the same, these terms are generally used interchangeably herein.

A computing system is operably coupled with the battery energy storage system, the charging station, and the electric resource(s). The computing system includes a processor and associated memory, with the memory storing instructions that, when implemented by the processor, configure the computing system to optimize charging routines of the electric resources. For instance, the computing system may be configured to determine a predicted time at which the electric resource(s) will require charging based at least in part on a current state of charge of the electric resource(s), current job assignment, future workflows, and/or the like. In turn, the computing system may determine a requested power load by the charging station at the predicted time and/or determine a defined power value of the grid interconnect at the predicted time. Thereafter, the computing system may determine one or more charging parameters based at least in part on the requested power load by the charging station at the predicted time and the defined power value of the grid interconnect at the predicted time. The computing system may further generate one or more commands for the battery energy storage system, the charging station, and/or the electric resource(s) for charging the electric resource(s) based on the one or more charging parameters.

As such, the systems and methods herein provide for controlling various assets at an electric resource (e.g., robot) charging site, including when the electric resource(s) should charge, a power limit of each respective charging station that supplies power to the electric resource(s), and/or a charge/discharge command for the stationary battery energy storage system with the capability to charge or discharge into a common AC or DC distribution assembly that is electrically connected to the charging station. By controlling the various assets, the electric resource(s) may be charged more efficiently with reference to completing jobs. Moreover, a more constant power draw (a term known as “peak shaving”) may be accomplished for the purposes of minimizing demand charges by electric utility companies for the facility. Additionally, or alternatively, the power draw of each charging system and/or charging station may be maintained below a defined power value, while allowing the power consuming items at the site to collectively and periodically exceed that limit with supplemental power being provided by the battery energy storage system.

In some instances, the computing system may calculate an economically optimal usage of site-level battery storage energy given historical knowledge about robot charging sessions at the charging site (e.g., charging site utilization). As such, the system described herein may form a high-quality charging experience for robot fleets, without requiring that site to meet the nameplate power capacity of its installed chargers, and without incurring exorbitant demand charges that may be present on the charging station operator's utility tariff. Moreover, by tracking charging patterns and power requests, the charging network provides a stronger, more sensitive prediction of peak loads and therefore allows a more aggressive peak shave target, ultimately resulting in increased economic benefit to the facility. Additionally, the charging network described herein can provide fast and secure control of power load generation at a site to allow the operation of chargers in situations where the total of the chargers'nameplate power limits exceed the grid power limit.

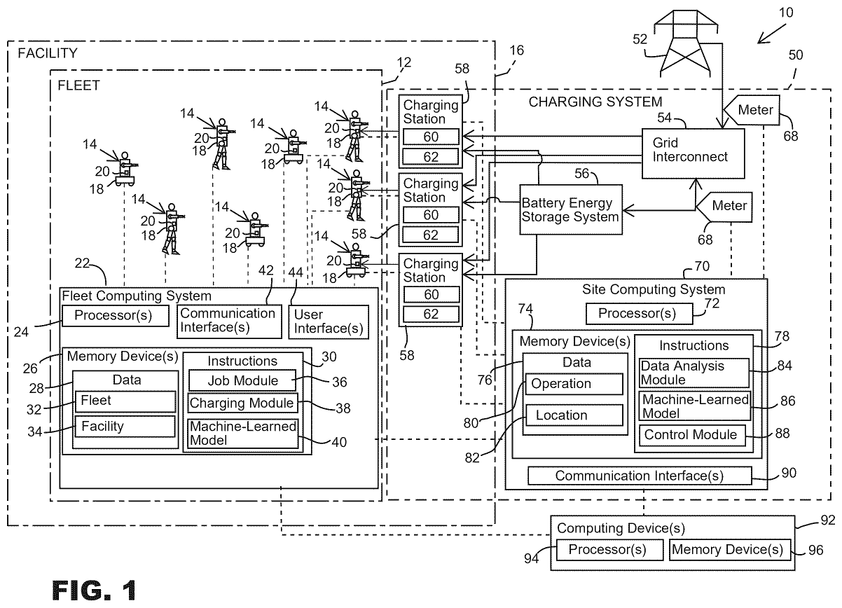

Referring now to FIG. 1, in some embodiments, a system 10 for charging a fleet of electric resources is shown. As used herein, “electric resource” typically refers to electrical entities that can be commanded to do some or all of these three things: take power (act as load), provide power (act as power generation or source), and store energy. For instance, the fleet of electric resources will be described herein as a fleet 12 of robots 14 at a facility 16. The robots 14 can be commanded by humans, run according to pre-arranged programs, and/or act autonomously according to the principles and programs formulated by artificial intelligence technology. An “autonomous robot” is used broadly herein to refer to robots that are configured to act at least partially autonomously (e.g., do not need to receive commands for each action from an external source). The robots 14 will be described throughout as being autonomous, but it should be appreciated that any other suitable robot with similar charging needs may instead, or additionally, be used.

A robot, as used herein, is intended to mean an electric robot or a hybrid robot that gets some or all of its energy for motion, decision-making, and other purposes from its battery. Moreover, the energy storage system of such robots may consist of batteries, capacitors, etc., or some combination thereof. A robot may or may not have the capability to provide power back to the electric grid. It should be appreciated that charging of any other suitable electric resource may benefit from the disclosure herein, such as for charging of electric vehicles, and/or the like. Additionally, as used herein, “facility” typically refers to a facility that is configured to use the “electric resource” for performing one or more jobs or tasks at such a facility. Suitable examples may include facilities for logistics, manufacturing, healthcare, hospitality, and/or the like. It will be appreciated that the charging system 50 provided herein may be implemented and used in any location with any object that may be charged and/or accept electricity for operation thereof.

The fleet 12 of robots 14 may include robots 14 having different configurations. For instance, as illustrated, a first type of the robots 14 may be configured with a wheeled transportation platform, while a second type of the robots 14 may be configured for transportation as a bi-ped. In some instances, the robots 14 may be humanoid robots, which resemble human beings in appearance and/or interactions. The robots 14 may include any suitable equipment for performing tasks within the facility 16. For example, the robots 14 may be equipped with a variety of different conveyor belts, handlers, manipulators, support platforms, payload carriers, trailers totes, sensor(s) (e.g., payload sensors, vision-based sensors (e.g., cameras, LiDAR sensors, radar sensors, and/or the like), position sensor(s) (e.g., GPS sensor(s)), acoustic sensors, etc.), user interface device(s) (e.g., display devices, lights, alarms, microphones, speakers, buttons, and/or the like), and/or the like. It should be appreciated that while only two robot configurations are shown, any suitable combinations of different configurations of robots may be used for forming the fleet 12. Moreover, it should be appreciated that, while only eight robots 14 are shown, any other suitable number of robots may instead be used for forming the fleet 12, including a fleet of only one robot. Similarly, it should be appreciated that while only one fleet 12 is shown, a facility 16 may be associated with multiple fleets 12 (e.g., for performing different tasks and/or focused on different locations at a facility). Additionally, it should be appreciated that, while the robots 14 are shown as being self-mobile, some robots 14 may be battery-operated, but not self-mobile (e.g., must be transported by another robot 14 and/or an operator).

The robots 14 may be configured to perform different tasks depending on the type of facility or job assignments at the facility. For instance, the robots 14 may, in some instances, be configured to perform hospitality services, and as such, may be configured to use artificial intelligence to converse with patrons and perform hospitality tasks. In one or more instances, the robots 14 may be configured to perform logistics services, and as such may be configured to use machine learning to pick and/or pack items from a warehouse for shipping. In another example, the robots 14 may be configured to use machine learning to perform manufacturing services, such as assembly, disassembly, machining, and/or the like. Such examples should not be construed as limiting.

Each of the robots 14 may include a corresponding battery assembly 18 and/or a computing system 20. The battery assembly 18 may consist of one or more of a plurality of individual batteries configured in a series, parallel, or combination of series and parallel connections. The battery assembly 18 may be configured to store and/or provide power for performing actions. For instance, the computing system 20 may include any suitable processor-based device(s) known in the art, such as a computing device or any suitable combination of computing devices. Thus, in several embodiments, the computing system 20 may include one or more processor(s) and associated memory device(s) configured to perform a variety of computer-implemented functions. The computing system 20 may be configured to control various components of the associated robot(s) 14. For instance, the computing system 20 may be configured to control various components of the associated robot(s) 14 to perform jobs. For example, the computing system 20 may be configured to receive a job instruction for the associated robot 14; evaluate one or more parameters of the associated robot 14 and/or the facility 16; determine one or more tasks to perform based on the parameters and the job instruction; and/or control the various equipment of the associated robot 14 to perform the tasks. In some instances, the computing system 20 may additionally, or alternatively, be configured to control the amount, direction, and timing of power being transferred into or out of a corresponding battery assembly 18; provide metering of power being transferred into or out of a corresponding battery assembly 18; provide safety measures during power transfer; log activities, and/or the like. In some instances, the computing system 20 may be configured to automatically recognize jobs needing to be performed (e.g., based on sensor data analysis, base programming, and/or the like) instead of, or in addition to, receiving a job instruction.

It should be appreciated that the computing system 20 may include one or more communication interface(s) that allow the robot 14 to communicate with any of the various other system components, such as other robots 14 of the fleet 12, a fleet computing system 22, and/or the like as will be described herein. For clarity purposes, solid connection lines in FIG. 1 indicate an energy transfer line between two components described herein, while dashed lines illustrate communication lines between two components described herein.

In some instances, the fleet 12 of robots 14 may be associated with a fleet computing system 22. The fleet computing system 22 may generally be configured to manage the assignment of jobs within the facility 16 across the fleet 12. In general, the fleet computing system 22 may include any suitable processor-based device(s), such as a computing device or any combination of computing devices. Thus, as shown in FIG. 1, the fleet computing system 22 may generally include one or more processor(s) 24 and associated memory devices 26 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 26 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 26 may generally be configured to store information accessible to the processor(s) 24, including data 28 that can be retrieved, manipulated, created, and/or stored by the processor(s) 24 and instructions 30 that can be executed by the processor(s) 24. The computing system 22 may include, for example, one or more mobile devices, tablet computers, laptop computers, desktop computers, and/or the like.

In several embodiments, the data 28 may be stored in one or more databases. For example, the memory 26 may include a fleet database 22 for storing fleet data received from one or more sources. For example, as illustrated, the fleet data may include a status profile and a configuration profile for each robot 14. The status profile may indicate a current condition of each robot 14 of the fleet 12, including, without limitation: a robot identifier; a robot position; a robot heading; a current robot speed; a current job identifier; a current job status; a current job location; a proximity to the current job location; a current job destination path; an estimated time of arrival; an estimated time of departure; a robot idle time; a robot security level; a robot battery charge level (state of charge); a robot payload status; a robot payload error condition; a robot cargo status, and/or the like. The configuration profile may indicate one or more of a wide variety of different current configurations for each robot 14 in the fleet 12, including, without limitation: a material handling capability; a material lifting capability; a material transporting capability; a manipulating capability; an object conveying capability; a measuring capability; a sensing capability; a pumping capability; a spraying capability; a vacuum capability; a drilling capability; a video recording capability; a sound recording capability; a sound producing capability; a navigation capability; a data input capability; a data output capability; a data communication capability; a printing capability; a displaying capability; a floor plan mapping capability; an energy absorption capability; an energy production capability; a maximum payload capability; a minimum payload capability; a maximum drive speed; a minimum drive speed; a maximum height; a minimum height; a location restriction; a zone restriction; a forbidden operation; a permitted operation; a minimum clearance requirement; and/or autonomy level. In some instances, the fleet data may be received from the robots 14 (e.g., from the computing system(s) 20 of the robots 14. However, the fleet data may be received from any other suitable source, such as from an operator (e.g., via user interface(s) 44, as will be described below) and/or sensors at the facility 16. For instance, one or more cameras may be positioned at the facility 16, where the cameras may capture data indicative of the status and/or configurations of the robot(s) 14 at the facility 16.

Additionally, as shown in FIG. 1, the memory 26 may include facility data in a facility database 34 that includes information or data associated with the facility 16. The facility data may be calculated or determined by the computing system 22 based on any data accessible to the system 10 (e.g., including data accessed, received, or transmitted from internal data sources and/or external data sources) and/or received from an external source. The facility data may include location information about the location of the facility 16 relative to a power grid, a layout the facility 16, different zones within the facility 16, power resource locations within the facility 16 (e.g., charging stations 58, as will be described below), jobs to be assigned within the facility 16, and/or the like. In some instances, the facility data may be received from any suitable source, such as from an operator (e.g., via user interface(s) 44, as will be described below), from the robots 14, and/or sensors at the facility 16. For instance, one or more cameras may be positioned at the facility 16, where the cameras may capture data indicative of a layout of the facility 16, power resource locations at the facility (e.g., charging stations 58, etc.), and/or the like.

Referring still to FIG. 1, in several embodiments, the instructions 30 stored within the memory 26 of the fleet computing system 22 may be executed by the processor(s) 24 to implement a job module 36. In general, the job module 36 may be configured to analyze the data 28 to select an appropriate robot 14 from the fleet 12 for each job request in the facility data based at least in part on the current statuses and configurations of the robots 14 in the fleet 12 and send a command instruction to the selected robot 14 that causes the selected robot to automatically perform the specified job operation. For instance, each job request in the facility data may have a list of associated attributes that a robot 14 must have in order to perform a task. The job module 36 may compare the list of associated attributes to the known configurations of robots 14 that are not currently engaged in a task and identify a suitable robot 14 that matches (or most closely matches) the requirements. If none of the robots 14 without a current task satisfies the required attributes, the job module 36 may compare the list of associated attributes to the known configurations of robots 14 that are currently engaged in a task. If a first one of the robots 14 currently engaged in a task matches the list of associated attributes for a first task, the job module 36 may decide whether the current task of the first robot 14 should be transferred to a different robot so that the first robot 14 may perform the first task and/or whether the first robot 14 should add the first task to their job queue to perform before or after finishing the current task.

It should be appreciated that the list of associated attributes may include sufficient battery charge to perform the task. As such, the job module 36 may also be configured, in some instances, to determine whether a particular robot 14 that is otherwise equipped for a task has sufficient battery charge to complete the task. For instance, the job module 36 may determine whether the robot 14 will be able to complete a task based on the current level of charge, historical battery discharge rates for the particular task, and/or the like.

In some instances, the job module 36 may be configured to divide tasks between multiple robots 14 and/or the fleet computing system 22 to reduce load for individual robots in performing a task. For instance, if an autonomous robot 14 is commanded to perform a customer service task that includes autonomously generating responses and/or autonomously performing service actions based on customer inputs, the computational load, and thus, the power load, for performing such task locally on the robot 14 may be high. As such, the job module 36 may generate a split command which splits a task across the autonomous robot 14 and one or more other robots 14 and/or the fleet computing system 22. For example, the autonomous robot 14 may relay the user inputs to the fleet computing system 22, the fleet computing system 22 may process the user inputs to generate a response, then the fleet computing system 22 may send instructions to the autonomous robot 14 based on the generated response, which conserves energy at the robot 14. It should be appreciated that, in some instances, the robot 14 may be assigned a particular task but perform the relay with another robot and/or the fleet computing system 22 to divide the computational load without explicit instructions from the job module 36.

Once a suitable robot 14 is determined for a task, the job module 36 may transmit instructions to the robot 14 that are necessary for the robot 14 to perform the task. For instance, the instructions transmitted to the robot 14 may include a location to perform the task, the goal of the task, and/or the like. Autonomous robots 14 may be able to make the necessary calculations and determinations to automatically carry out the task without step-by-step instructions. Robots 14 with lower levels or without any autonomy may require more instructions (e.g., step-by-step navigation and/or action instructions).

Referring still to FIG. 1, the instructions 30 stored within the memory 26 of the computing system 22 may also be executed by the processor(s) 24 to implement a charging module 38. In general, the charging module 38 may be configured to instruct robots 14 of the fleet 12 to charge. The charging module 38 may instruct each of the robots 14 which charging station 58 to charge at, when to begin a charge, how long to charge (e.g., length of time to charge), how much to charge (e.g., to a particular state of charge), and/or the like. As such, the charging module 38 may be configured to determine one or more charging parameters (e.g., a power load, a voltage, a current, an amount of time, and/or any other charging parameters) for charging the robot(s) 14. In some instances, robots 14 which are identified in the job module 36 as not comprising sufficient charge for any of the jobs in the facility data may be automatically selected by the charging module 38 as requiring charging. The charging module 38 may be configured to optimize charging and job completion. For instance, if it is more beneficial for one or more 14 to continue working instead of charging, the charging module 38 may wait until a task is done before sending the robot(s) 14 to charge. Similarly, in some instances, the charging module 38 may shuffle job tasks between robots 14 to allow for other robots 14 to charge. Additionally, or alternatively, the charging module 38 may adjust a power usage strategy of the robot(s) 14. For instance, if a battery level of charge of one of the robots 14 drops below a minimum charge threshold (e.g., during a lower charging priority window), the charging module 38 may recommend to the job module 36 that certain functions of the robot 14 may be disabled and/or demoted (e.g., slower and/or less precise) to conserve the battery life. Similarly, in some instances, the charging module 38 may recommend to the job module 36 that split commands be implemented to conserve battery life (e.g., during a lower charging priority window). Conversely, if the battery level of charge is above the minimum charge threshold, the charging module 38 may recommend to the job module 36 that certain functions of the robot 14 may be re-enabled and/or upgraded (e.g., faster and/or more precise), and/or that split commands be de-prioritized.

In some instances, the job module 36 and/or the charging module 38 may cooperatively operate with or otherwise leverage a machine-learned model 40 to analyze the data 28 to perform the operations described above.

Moreover, as shown in FIG. 1, the fleet computing system 22 may also include one or more communications interfaces 42 to communicate with any of the various other system components described herein. For instance, one or more communicative links or interfaces (e.g., one or more data buses and/or wireless connections) may be provided between the communications interface(s) 42 and the individual robots 14 (e.g., with the communications interfaces of the computing systems 20 of the robots 14) to allow data transmitted from the computing system 22 to be received by the robots 14 and/or to allow data transmitted by the robots 14 to be received by the computing system 22.

Additionally, the fleet computing system 22 may include or be associated with one or more user interface(s) 44. The user interface(s) 44 may correspond to any suitable input device(s) configured to allow an operator to provide operator inputs to the fleet computing system 22, such as a touch screen display, a keyboard, joystick, buttons, knobs, switches, and/or combinations thereof. In addition, the user interface(s) 44 may also be configured to provide feedback to the operator. As such, the user interface(s) 44 may include one or more output devices (not shown), such as display screens, speakers, warning lights, and/or the like, which are configured to provide feedback from the fleet computing system 22 to the operator. It should be appreciated that the user interface(s) may be integrated into the computing system 22 and/or may be remote from the computing system 22.

It should be appreciated that by having the fleet computing system 22 at the facility 16 in communication with the fleet 12 of robots 14, any latency of communication between the fleet 12 and the fleet computing system 22 will be significantly lower compared to latency of communication between the fleet 12 and a cloud computing system. For instance, tasks split between the fleet 12 and the fleet computing system 22 may be significantly faster due to the local communication in comparison to tasks split between the fleet 12 and a remote, cloud computing system.

As described above, the fleet 12 of robots 14 within the facility 16 may make up a large portion of the power demand of the facility 16. Moreover, the time for charging each of the robots 14 may be significant, and the downtime while charging is not ideal for productivity. Additionally, utility companies determine how to allocate energy resources based on continuously varied supply and demand. As a result, charging systems for such fleets 12 may be limited in power, leading to varied charging rates (e.g., times) and rate costs. Therefore, systems and related methods that can increase the efficiency of charging robot fleets would be welcomed by the industry.

Thus, in accordance with aspects of the present subject matter, one or more fleets, such as the fleet 12, may be configured to cooperate with a charging system 50 that is configured to increase the efficiency of charging the electric resources (e.g., robots 14) of the associated fleets 12. For instance, a charging system 50 may be configured for controlling various electric components at one or more defined locations for controlling charging of associated fleets 12 of one or more electric resources, such as one or more robots 14, at a facility 16. It should be appreciated that, while the charging system 50 is only shown with reference to the single fleet 12 at the facility 16, the charging system 50 may be in communication with multiple fleets 12 across one or more different facilities.

As illustrated, the charging system 50 can include a grid interconnect 54 that may be operably coupled with a power grid 52. The “power grid” as used herein means a power distribution system/network that connects producers of power with consumers of power. The network may include generators, transformers, interconnects, switching stations, and safety equipment as part of either/both the transmission system (i.e., bulk power) or the distribution system (i.e. retail power). The power aggregation system is vertically scalable for use within a neighborhood, a city, a sector, a control area, or (for example) one of the eight large-scale Interconnects in the North American Electric Reliability Council (NERC). Moreover, the system is horizontally scalable for use in providing power services to multiple grid areas simultaneously.

The charging system 50 may also include a battery energy storage system 56, which may be operably coupled with the grid interconnect 54. The battery energy storage system 56 may consist of one or more of a plurality of individual batteries configured in a series, parallel, or combination of series and parallel connections. In various examples, the battery energy storage system 56 may have a nominal voltage of up to 800 volts (V) and can store 200 kilo-Watt-hours (kWh) of energy. As illustrated, the battery energy storage system 56 may transfer power stored therein to one or more of the charging stations 58 and/or to the grid interconnect 54 so that the power may be provided to the grid 52. As such, in some examples, the battery energy storage system 56 may include power electronic components to form a bi-directional AC-DC converter-inverter that can both convert AC to DC and invert DC to AC using the same circuit topography. Additionally, or alternatively, multiple inverters/converters may be implemented without departing from the scope of the present disclosure.

Each charging system 50 may be remote from the battery energy storage system 56 and the grid interconnect 54 and/or the battery energy storage system 56. In general, each charging system 50 may convert energy from the grid interconnect 54 and/or the battery energy storage system 56, using energy conversion techniques such as, but not limited to, DC to DC conversion, AC to DC conversion, DC to AC conversion, AC to AC conversion, current limiting and voltage regulation, as determined, at least in part, by the charging requirements of the autonomous robot(s) 14 and/or requirements of the fleet operator (e.g., the owner, custodian or other person available to specify such requirements).

In various examples, the charging system 50 may further include one or more charging stations 58 at the facility 16. Each charging station 58 may include and/or be operably coupled with a power distribution assembly 60 and/or a controller 62. Power may be provided from the charging station 58 to the robot 14 during a charging session that begins when the power is transferred from the charging station to the robot 14 and ceases when power is no longer being transferred. In various instances, the amount of power may vary over time during the charging session as necessary to improve factors including, but not limited to, charger unit efficiency, charge time, battery life, and/or charging cost to the fleet operator. In general, the power distribution assembly 60 may contain power electronic components to form a bi-directional AC-DC converter-inverter that can both convert AC to DC and invert DC to AC using the same circuit topography. A converter-inverter topography allows the charging system 50 to interchangeably and/or supplementarily use AC power from the grid 52 and/or DC power from the battery energy storage system 56 based on certain conditions, such as when power rates are low cost or when the percentage of renewable energy generation entering the grid 52 is high. It should be appreciated that the charging stations 58 may charge the batteries 18 of the robots 14 without such batteries 18 being disconnected from the robots 14 and/or in some instances, the charging stations 58 may charge a bank of batteries which may be physically swapped with the batteries 18 onboard the robots 14.

In general, the controller 62 of the charging station(s) 58 may comprise any suitable processor-based device known in the art, such as a computing device or any suitable combination of computing devices. Thus, in several embodiments, the controller 62 may include one or more processor(s) and associated memory device(s) configured to perform a variety of computer-implemented functions. It will be appreciated that, in several embodiments, the controller 62 may correspond to an existing controller of the charging station 58, or the controller 62 may correspond to a separate processing device. The controller(s) 62 may be configured to control various components of the power distribution assembly(ies) 60. For instance, the controller(s) 62 may control the amount, direction, and timing of power being transferred into or out of a connected autonomous robot 14; providing metering of power being transferred into or out of a connected autonomous robot 14; providing safety measures during power transfer and changes of conditions in the power grid 52; logging activities; providing self-contained control of power transfer and safety measures when communication with other components of the charging system 50 is interrupted, and/or the like.

Each charging station 58 may be respectively, selectively coupled with an electric resource (e.g., autonomous robot 14) for providing power thereto. As described above, each participating autonomous robot 14 (e.g., of fleet 12) has the corresponding battery assembly 18 and/or the computing system 20. In various examples, the charging system 50 (e.g., the controller(s) 62) may communicate with the computing systems 20 distributed peripherally among the autonomous robots 14. The controller(s) 62 of the charging station(s) 58 may perform several different functions, including, but not limited to, providing the charging system 50 with the statuses (e.g., state of charge, charging state, and/or the like) of the remote autonomous robots 14; controlling the amount, direction, and timing of power being transferred into or out of a remote autonomous robot 14; providing metering of power being transferred into or out of a remote autonomous robot 14; providing safety measures during power transfer and changes of conditions in the power grid 52; logging activities; and providing self-contained control of power transfer and safety measures when communication with the charging system 50 is interrupted. In some instances, the controller(s) 62 of the charging station(s) 58 may collaborate with the computing system(s) 20 of the robots 14 and/or the fleet computing system(s) 22 to provide one or more of such functions.

Moreover, the charging system 50 can also include a site computing system 70. In general, the computing system 70 may correspond to any suitable processor-based device(s), such as a computing device or any combination of computing devices. Thus, as shown in FIG. 1, the computing system 70 may generally include one or more processors 72 and associated memory devices 74 configured to perform a variety of computer-implemented functions (e.g., performing the methods, steps, algorithms, calculations, and the like disclosed herein). Additionally, the memory 74 may generally be configured to store information accessible to the processor(s) 72, including data 76 that can be retrieved, manipulated, created, and/or stored by the processor(s) 72 and instructions 78 that can be executed by the processor(s) 72. While the computing system 70 is shown as a component of the charging system 50, it will be appreciated that the computing system 70 may be remote from the charging system 50 without departing from the scope of the present disclosure.

In several embodiments, the data 76 may be stored in one or more databases. For example, the memory 74 may include an operation database 80 for storing operational data received from one or more components of the charging system 50 regarding the charging system 50. For example, as illustrated, one or more meters 68 may be operably coupled with various connection lines and the site computing system 70. Each meter 68 may be configured to measure the amount of electric energy in a defined location. For example, as shown in FIG. 1, a first meter 68 may be operably coupled with a connection line between the grid 52 and the grid interconnect 54 (and/or any other position upstream of the grid interconnect 54). As such, the first meter 68 may be capable of measuring the power load that is being provided from the grid 52 to the grid interconnect 54. Additionally, or alternatively, a second meter 68 may be operably coupled with a connection line between the grid interconnect 54 and the battery energy storage system 56. As such, the second meter 68 may be capable of measuring a power load that is being transferred from the grid interconnect 54 to the battery energy storage system 56, and/or from the battery energy storage system 56 to the grid interconnect 54. Additionally, or alternatively, the controllers 62 of the one or more charging stations 58 may provide operational data to the computing system 70.

Additionally, as shown in FIG. 1, the memory 74 may include a location database 82 storing location information about the location of the charging system 50 and/or the customers of such charging system 50. The stored data may be determined by the computing system 70 based on any data accessible to the system 10 (e.g., including data accessed, received, or transmitted from internal data sources and/or external data sources) and/or received from an external source. For instance, in several embodiments, the location data may, additionally or alternatively, include data received from the fleet 12, such as from the fleet computing system 22 and/or the robots 14.

As will be described in greater detail below, the data 76 may be used to determine various predicted operating conditions, such as a predicted power load that will be consumed by one or more robots 14 during a defined time frame, and/or to determine preferred windows for charging the robots 14 based at least on such predicted operating conditions.

Referring still to FIG. 1, in several embodiments, the instructions 78 stored within the memory 74 of the computing system 70 may be executed by the processor(s) 72 to implement a data analysis module 84. In general, the data analysis module 84 may be configured to analyze the data 76 to determine one or more charging parameters (e.g., a power load, an energy source to supply the energy (e.g., the grid 52 and/or the battery energy storage system 56), a voltage, a current, an amount of time, a starting time, and/or any the like) for charging the robot(s) 14. In some instances, the data analysis module 84 can cooperatively operate with the fleet computing system 22 and/or leverage a machine-learned model 86 to analyze the data 76 to determine the one or more charging parameters.

Referring still to FIG. 1, the instructions 78 stored within the memory 74 of the computing system 70 may also be executed by the processor(s) 72 to implement a control module 88. In general, the control module 88 may be configured to adjust the operation of the charging system 50 by controlling one or more components of the charging system 50. In several embodiments, the control module 88 may be configured to automatically control the operation of one or more components of the charging system 50 based at least in part on the data. In some instances, the control module 88 may additionally, or alternatively, be configured to adjust operation of the fleet 12. For instance, the control module 88 may generate instructions defining one or more charging parameters which may be provided to the fleet computing system 22, where the fleet computing system 22 may then instruct robots 14 of the fleet 12. Thus, the system 10 can reactively manage charging by controlling each respective charging station 58 and/or can proactively manage charging by adjusting operation of the fleet 12 (directly or indirectly) based on the determined charging parameters.

Moreover, as shown in FIG. 1, the computing system 70 may also include a communications interface 90 to communicate with any of the various other system components described herein. For instance, one or more communicative links or interfaces (e.g., one or more data buses and/or wireless connections) may be provided between the communications interface 90 and the meters 68 such that data transmitted from the meters 68 may be received by the computing system 70. Further, as shown in FIG. 1, one or more communicative links or interfaces (e.g., one or more data buses and/or wireless connections) may be provided between the communications interface 90 and the charging stations 58 and/or the battery energy storage system 56 to allow the computing system 70 to control the operation of such components of the charging system 50. Additionally, one or more communicative links or interfaces (e.g., one or more data buses and/or wireless connections) may be provided between the communications interface 90 and the fleet 12 (e.g., the fleet computing system 22 of the fleet 12) to allow the computing system 70 to transmit and/or receive data from the fleet 12.

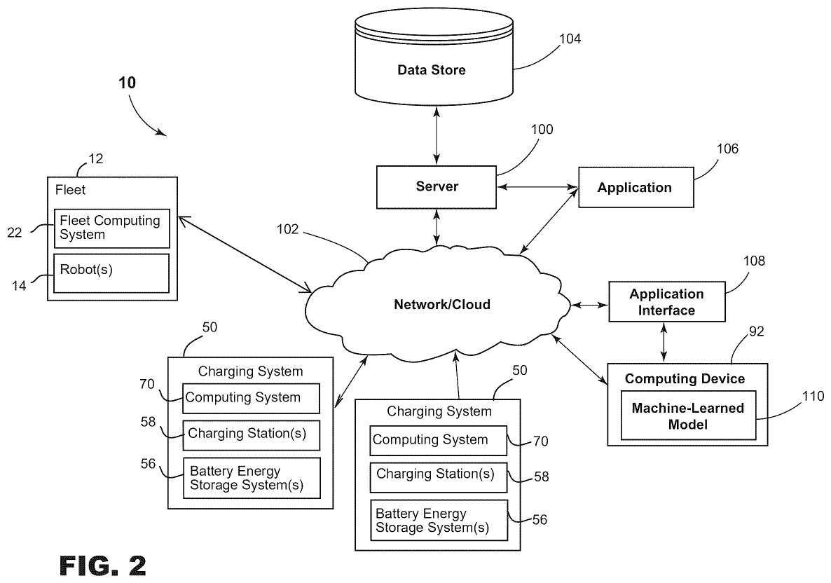

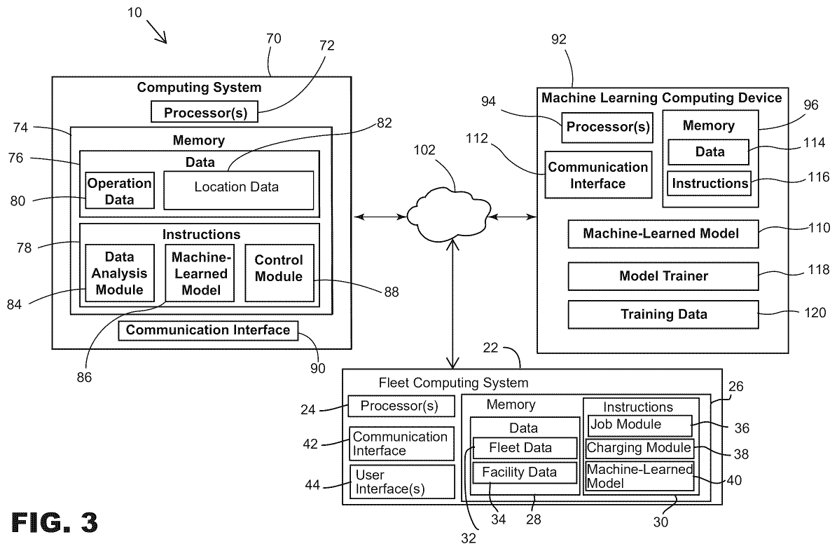

Additionally, or alternatively, the charging system 50 may also interface with one or more remote computing devices 92. In some instances, the computing device 92 may include one or more processor-based devices, such as a given controller or computing device or any suitable combination of controllers or computing devices. Thus, in several embodiments, the computing device 92 may include one or more processors 94 and one or more associated memory devices 96 configured to perform a variety of computer-implemented functions. Additionally, the memory device(s) 96 of the computing device 92 may generally be configured to store suitable computer-readable instructions that, when implemented by the processor(s) 94, configure the computing device 92 to perform various computer-implemented functions, such as one or more aspects of the methods and algorithms that will be described herein. In addition, the computing device 92 may also include various other suitable components, such as a communications interface 112 (FIG. 3), one or more input/output channels, a data/control bus, and/or the like. It should be appreciated that the various functions of the computing device 92 may be performed by a single processor-based device or may be distributed across any number of processor-based devices, in which instance such devices may be considered to form part of the computing device 92. For instance, the functions of the computing device 92 may be distributed across multiple application-specific controllers. In some instances, the computing device 92 may be a mobile device, tablet computer, laptop computer, desktop computer, watch, virtual reality device, television, monitor, or any other computing device or another visual device. In some instances, the computing device 92 may implement a machine-learned model 110 (FIG. 2).

In operation, the computing system 70 may evaluate the data 76 to optimize use of the charging system 50. For instance, the data analysis module 84 may evaluate the available operation data, which can at least include the current (present) demanded load profile (e.g., present load being drawn at the charging station(s) 58), current power supply to/from the grid 52 (e.g., based on meter(s) 68), current rate (cost and/or speed) for receiving power from the grid 52, current charge level of the battery energy storage system 56, and/or the like. In addition, the data analysis module 84 may evaluate the location data, which can include a requested or predicted load profile (e.g., based on the charging instructions determined by the fleet charging system 22, such as from the charging module 38), historical energy data usage of the charging system 50 and/or the facility 16 (e.g., of the fleet 12), historical rate data (e.g., cost and/or speed of power supply from the grid 52), and/or the like. Based on the data 76, the data analysis module 84 of the computing system 70 may predict expected power load and/or expected fees for charging the fleet 12 at defined periods, then generate recommendations for optimizing charging the fleet 12 to reduce requested power loads and/or reduce costs. Additionally, or alternatively, the data from the charging system 50 may be provided to the remote computing device 92, which may predict robot flow and expected power load over defined periods for one or more charging systems 50.

For instance, the data analysis module 84 may leverage a peak shaving estimation algorithm that produces a peak shave target for the battery energy storage system 56. Additionally, or alternatively, the control module 88 may implement a closed-loop control that generates charging system commands for operating the charging system 50 to maintain the power load from the grid interconnect 54 below a defined power value and/or cost. For instance, the charging system commands may be based on or include charging parameters, such as power limit commands to each respective charging station 58, with active sessions to maintain the power load from the grid interconnect 54 below a defined power value. As such, according to some examples, the charging system 50 may define one or more charging parameters (such as a maximum power limit) for one more charging stations 58 that supply power to the robots 14. For instance, based on the number of robots 14 and the amount of available energy, the charging system 50 may manage the amount of power provided to each respective charging station 58 independently.

In some examples, the power load provided to each charging station 58 (e.g., from the grid interconnect 54 and/or the battery energy storage system 56) may be varied over time based on one or more factors. For instance, the power load provided may be based on the amount of time that a robot 14 receives energy from the charging station 58. Additionally, or alternatively, the power load provided may be based on information provided by the modules of each robot 14 and/or the fleet computing system 22. Additionally, or alternatively, the power load provided may be at least partially based on the number of electric resources (e.g., robots 14), the power load provided by the grid 52, and/or the amount of power stored within the battery energy storage system 56.

The amount of power may further be varied based on the predictive models of upcoming changes in the number of robots 14 that are to be operably coupled with the charging system 50. For example, if the power load provided by the grid 52 is less than the amount to be outputted to the one or more robots 14, the computing system 70 may supplement the grid power with power from the battery energy storage system 56. Moreover, the power load provided from the grid 52 may be varied based on the energy cost for a defined period for charging a given robot 14, which may be, for example, eight hours or less, such as four hours or less, such as about two hours or less, and/or the like.

In some instances, the data analysis module 84 may additionally, or alternatively, indicate priority charging time windows based on the charging system 50, such as higher priority charging times, where charging of the fleet 12 should be prioritized, or lower priority charging times, where charging of the fleet 12 should be deprioritized. Based on such charging time windows, the fleet computing system 22 may optimize fleet commands for charging and job completion of the fleet 12. For instance, if a lower priority charging time window is in place or predicted for a given time when charging would be necessary for the robot(s) 14, it is more beneficial for one or more of the robots 14 to continue working instead of charging during such window, and the charging module 38 may wait until a higher priority charging time is present or predicted before sending the robot(s) 14 to charge. Conversely, if a higher priority charging time window is in place or predicted for a given time when charging would be necessary for the robot(s) 14, it is more beneficial for one or more of the robots 14 to charge instead of continuing working during such window, and the charging module 38 may send the robot(s) 14 to charge during such window with more priority than job completion. It should be appreciated that the different charging time window priorities may be associated with different weights for charging and job tasks within an algorithm for making job and/or charging commands. For instance, the higher priority charging window may adjust weights such that charging is prioritized higher or more heavily than job tasks, while the lower priority charging window may adjust weights such that job tasks are prioritized higher or more heavily than charging tasks. For instance, the fleet computing system may generate more charge commands than job commands for a higher priority charging window or, conversely, more job commands than charge commands for a lower priority charging window. Additionally, or alternatively, the priority charging windows may be used by the fleet computing system 22 to adjust power usage strategies (e.g., reduce power usage during the lower priority charting window). With robots 14 of higher autonomy levels, the useful workday of the robots 14 may extend beyond a typical useful workday of humans, and as such, the working window for the robots 14 may be more easily shifted based on the priority charging time windows compared to electric resources that are at least partially operator operated (e.g., electric vehicles). For the case of electric vehicles, the charging commands may include providing notifications (e.g., via user interfaces) to operators of the electric vehicles when higher priority charging windows are expected or in place that may be beneficial to make use of.

Referring now to FIG. 2, a block diagram illustrating components of the system 10 of FIG. 1 operably coupled with a remote server is illustrated in accordance with aspects of the present subject matter. For instance, the system 10 is an example of a charging network having one or more charging systems, such as one or more of the charging system 50, for charging one or more fleets, such as one or more of the fleet 12. In some examples, the charging systems 50 may be communicatively coupled with one or more remote sites, such as a remote server 100 via a network/cloud 102 to provide data and/or other information therebetween. The network/cloud 102 represents one or more systems by which the fleet(s) 12, the charging system(s) 50, and/or the computing device(s) 92 may communicate with the remote server 100. The network/cloud 102 may be one or more of various wired or wireless communication mechanisms, including any desired combination of wired and/or wireless communication mechanisms and any desired network topology (or topologies when multiple communication mechanisms are utilized). Exemplary communication networks include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources is generally illustrated, extended networks such as the Internet are often depicted as a cloud (e.g. cloud 102 in FIG. 2). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 102.

The server 100 may be one or more computer servers, each of which may include at least one processor and at least one memory, the memory storing instructions executable by the processor, including instructions for carrying out various steps and processes. The server 100 may include or be communicatively coupled to a data store 104 for storing collected data as well as instructions for the fleet(s) 12, the charging system(s) 50, and/or the computing device(s) 92 with or without intervention from a user. Moreover, the server 100 may be capable of analyzing initial or raw data received from the fleet(s) 12, the charging system(s) 50, and/or the computing device(s) 92 and final or post-processing data (as well as any intermediate data created during data processing). Accordingly, the instructions provided to any one or more of the fleet(s) 12, the charging system(s) 50, and/or the computing device(s) 92 may be determined and generated by the server 100 and/or one or more cloud-based applications 106.

With further reference to FIG. 2, the server 100 can also generally implement features that may enable the fleet(s) 12, the charging system(s) 50, and/or the computing device(s) 92 to communicate with cloud-based applications 106. Communications from the fleet(s) 12, the charging system(s) 50, and/or the computing device(s) 92 can be directed through the network/cloud 102 to the server 100 and/or cloud-based applications 106 with or without a networking device, such as a router and/or modem. Additionally, communications from the cloud-based applications 106, even though these communications may indicate one of the fleet(s) 12, the charging system(s) 50, and/or the computing device(s) 92 as an intended recipient, can also be directed to the server 100. The cloud-based applications 106 are generally any appropriate services or applications 106 that are accessible through any part of the network/cloud 102 and may be capable of interacting with the fleet(s) 12, the charging system(s) 50, and/or the computing device(s) 92.

In various examples, the fleet(s) 12, the charging system(s) 50, and/or the computing device(s) 92 can be feature-rich with respect to communication capabilities, i.e. have built-in capabilities to access the network/cloud 102 and any of the cloud-based applications 106 or can be loaded with, or programmed to have such capabilities. The fleet(s) 12, the charging system(s) 50, and/or the computing device(s) 92 can also access any part of the network/cloud 102 through industry-standard wired or wireless access points, cell phones, or network nodes. In some examples, users can register to use the remote server 100 through the fleet(s) 12, the charging system(s) 50, and/or the computing device(s) 92, which may provide access to the fleet(s) 12, the charging system(s) 50, and/or the computing device(s) 92 and/or thereby allow the server 100 to communicate directly or indirectly with the fleet(s) 12, the charging system(s) 50, and/or the computing device(s) 92. According to some examples, the fleet(s) 12, the charging system(s) 50, and/or the computing device(s) 92 can be preconfigured at the time of manufacture with a communication address (e.g. a URL, an IP address, etc.) for communicating with the server 100 and may or may not have the ability to upgrade or change or add to the preconfigured communication address.

Referring still to FIG. 2, when a new cloud-based application 106 is developed and introduced, the server 100 can be upgraded to be able to receive communications for the new cloud-based application 106 and to translate communications between the new protocol and the protocol used by the fleet(s) 12, the charging system(s) 50, and/or the computing device(s) 92. The flexibility, scalability, and upgradeability of current server technology render the task of adding new cloud-based application protocols to the server 100 relatively quick and easy.

In several embodiments, an application interface 108 may be operably coupled with the cloud 102 and/or the application 106. The application interface 108 may be configured to receive data related to one or more of the fleet(s) 12, the charging system(s) 50, and/or the computing device(s) 92. In some examples, at various predefined periods and/or times, the fleet(s) 12, the charging system(s) 50, and/or the computing device(s) 92 may communicate with the server 100 through the network/cloud 102 to obtain the stored instructions, if any exist. Upon receiving the stored instructions, the fleet(s) 12, the charging system(s) 50, and/or the computing device(s) 92 may implement the instructions.

Referring now to FIG. 3, a schematic block diagram illustrating portions of the system 10 of FIG. 1 is illustrated in accordance with aspects of the present subject matter. For instance, according to some aspects of the present disclosure, the system 10 can store or include one or more models, which may be machine-learned models. For example, the fleet computing system 22 may include (or otherwise have access to) the machine-learned model 40, the site computing system 70 may include (or otherwise have access to) the machine-learned model 86, and/or the external computing device 92 may include (or otherwise have access to) the machine-learned model 110.

As introduced above, the machine learning computing device 92 includes the processor(s) 94 and the memory device(s) 96. The one or more processor(s) 94 can be any suitable processing device such as described with reference to processor(s) 24, 72. The memory device(s) 96 can include any suitable storage device such as described with reference to memory device(s) 26, 74. The memory device(s) 96 can store information that can be accessed by the one or more processor(s) 94. For instance, the memory device(s) 96 (e.g., one or more non-transitory computer-readable storage mediums, memory devices) can store data 114 that can be obtained, received, accessed, written, manipulated, created, and/or stored. In some embodiments, the machine learning computing device 92 can obtain data from one or more memory device(s) that are remote from the computing device 92.

The memory device(s) 96 can also store computer-readable instructions 116 that can be executed by the processor(s) 94. The instructions 116 can be software written in any suitable programming language or can be implemented in hardware. Additionally, or alternatively, the instructions 116 can be executed in logically and/or virtually separate threads on the processor(s) 94. For example, the memory device(s) 96 can store instructions 116 that when executed by the processor(s) 94 cause the processor(s) 94 to perform any of the operations and/or functions described herein.

In some embodiments, the machine learning computing device 92 includes one or more server computing devices. If the machine learning computing device 92 includes multiple server computing devices, such server computing devices can operate according to various computing architectures, including, for example, sequential computing architectures, parallel computing architectures, or some combination thereof.

The machine-learned model 40 may include a machine-learned job estimation model. In various examples, the machine-learned job estimation model can be configured to receive data (e.g., the data 28) and process the input data to estimate the frequency and type of jobs that will likely be received during a future period to be assigned to the fleet 12. In some instances, the machine-learned job estimation model may further determine power needed to complete the predicted jobs. In one or more instances, the machine-learned job estimation model may further be configured to determine job assignment across the fleet 12.

In some instances, the machine-learned model 40 may include a machine-learned charging estimation model. In various examples, the machine-learned charging estimation model can be configured to receive data (e.g., the data 28) and process the input data to estimate when and for how long each of the robots 14 will need to charge for a future period. In some instances, as described above, the machine-learned charging estimation model may further take into account time windows determined by the site computing system 70.

Similarly, the machine-learned model 86 may include a machine-learned future load profile estimation model. In various examples, the machine-learned future load profile estimation model can be configured to receive data (e.g., the data 76) and process the input data to estimate an upcoming load profile, which may be based on a predicted number of robots 14 for a future period.

Additionally, or alternatively, the machine-learned model 86 may include a peak shaving estimation model that is configured to determine a peak shave target for the battery energy storage system 56 within each charging system 50. In several examples, the peak shaving estimation model may be configured to determine whether to supply energy from the battery energy storage system 56 and/or the grid 52 to each charging system 50 based on various factors, such as the power needs of the robot 14, the number of robots 14 electrically coupled with the charging system 50, the total power needs of the robots 14 in total, the power load stored within the battery energy storage system 56, the current cost per energy unit of energy from the grid 52, and/or any other factor. As such, the peak shaving estimation model may algorithmically determine whether to charge or discharge the battery energy storage system 56 and/or at what power load to achieve a desired peak shave performance. In some instances, the output of the peak shaving estimation model may include one or more recommended charging priority windows, which may be provided to the fleet computing system 22, such that the fleet computing system 22 may adjust control of the fleet 12 for job and/or charging assignment.

Additionally, or alternatively, the machine-learned model 86 may be implemented for use by a control model that seeks to operate the battery energy storage system 56 and issue power limits to each charger station with active sessions to maintain a power load from the grid interconnect 54 below a defined power value. In one non-limiting example, four robots 14 may each request one unit of energy from the charging station 58, but the defined supply power value of the interconnect 54 for energy from the grid 52 may be limited to two units of energy. In such instances, the computing system 70 may instruct the battery energy storage system 56 to provide an additional two units of energy so that the robots 14 may be efficiently charged while maintaining the units of energy at or below the defined power value at the interconnect 54. As such, the control model may generate instructions for the charging system 50 that can include a charge/discharge command from the battery energy storage system 56 and/or charging parameters for each charging station 58.

In some embodiments, the machine learning computing device 92 can communicate with the computing system(s) 22, 70 according to a client-server relationship. For example, the machine learning computing device 92 can implement the machine-learned model 110 to provide a web-based service to the computing system(s) 22, 70. For example, the web-based service can provide data analysis for determining a charge/discharge command for the battery energy storage system 56, one or more charging parameters for respective charging stations 58, one or more priority charging windows for the charging system 50, one or more job assignments for the fleet 12, one or more charging assignments for the fleet 12, and/or the like.

In addition or alternative to the model(s) 40, 86 at the computing system(s) 22, 70, the machine learning computing device 92 can include the machine-learned model(s) 110, where the model(s) 110 can be the same as described above with reference to the model(s) 40, 86.

Thus, machine-learned model(s) 40, 86 can be located and used at the computing system(s) 22, 70, and/or the machine-learned models 110 can be located and used at the machine-learning computing device 92.

In some examples, one or more of the models 40, 86, 110, which may be implemented by any module, can correspond to a linear machine-learned model. For instance, one or more of the models may be or include a linear regression model. For example, a linear regression model may be used to intake the input data from the charging system(s) 50 and provide intermittent or continuous outputs for the charging stations 58, the battery energy storage system 56, and/or the fleet computing system 22. Linear regression models may rely on various techniques, such as ordinary least squares, ridge regression, lasso, gradient descent, and/or the like. However, in other embodiments, one or more of the models may be or include any other suitable linear machine-learned model.

Alternatively, one or more of the models 40, 86, 110 may correspond to a non-linear machine-learned model. For instance, one or more of the models may be or include a neural network such as, for example, a convolutional neural network. Example neural networks include feed-forward neural networks, recurrent neural networks (e.g., long short-term memory recurrent neural networks), convolutional neural networks, transformer neural networks (or any other models that perform self-attention), or other forms of neural networks. Neural networks can include multiple connected layers of neurons and networks with one or more hidden layers, which can be referred to as “deep” neural networks. Typically, at least some of the neurons in a neural network include non-linear activation functions.

As further examples, one or more of the models can be or can otherwise include various other machine-learned models, such as a support vector machine; one or more decision-tree based models (e.g., random forest models); a Bayes classifier; a K-nearest neighbor classifier; and/or other types of models including both linear models and non-linear models.

In some embodiments, the system 10 can receive the one or more machine-learned models 40, 86, 110 from the computing device(s) 22, 70, 92 over the network 102 (FIG. 2) and/or can store the one or more machine-learned models 40, 86, 110 in the memory 26, 74, 96. The system 10 can then use or otherwise run the one or more machine-learned models 40, 86, 110 (e.g., by processor(s) 24, 72, 94).

In one or more embodiments, the computing device(s) 22, 70, 92 may be configured to train the machine-learned models 40, 86, 110 through the use of a model trainer. For instance, a model trainer 118 of the machine-learning computing device 92 can train one or more of the machine-learned models 40, 86, 110 using one or more training or learning algorithms. One example training technique is the backward propagation of errors (“backpropagation”), or other training techniques can be used.

In some embodiments, the model trainer 118 can perform supervised training techniques using a set of training data 120. For example, the training data 120 can include operational data from the charging systems 50 that is associated with a known value for the target parameter (e.g., a power load, an energy source (e.g., the grid 52 and/or the battery energy storage system 56) to supply the energy, a voltage, a current, an amount of time, etc.). For instance, operational data associated with the training dataset may be continuously collected, generated, and/or received while the charging system 50 is being used via monitoring means to provide matching or correlation datasets between the data from the robot computing system(s) 20 and the charging parameter data. In other embodiments, the model trainer 118 can perform unsupervised training techniques. The model trainer 118 can perform several generalization techniques to improve the generalization capability of the models being trained. Generalization techniques include weight decays, dropouts, or other techniques. The model trainer 118 can be implemented in hardware, software, firmware, or combinations thereof.

Thus, in some embodiments, the models can be trained at a centralized computing system (e.g., at “the factory”, such as the computing device 92) and then distributed to (e.g., transferred to for storage by) specific computing devices (e.g., the computing system(s) 22, 70) through the communications interface 112. Additionally, or alternatively, the models can be trained (or re-trained) based on additional training data generated by users or operators of the system. This process may be referred to as the “personalization” of the models and may allow operators to further train the models to provide improved (e.g., more accurate) predictions for unique field and/or machine conditions experienced by such operators.

FIGS. 1-3 illustrate example computing systems that can be used to implement the present disclosure. Other computing systems can be used as well. For example, in some embodiments, the computing system 22 and/or the computing system 70 can include the model trainer 118 and the training dataset 120. In such embodiments, the machine-learned model(s) 40, 86 can be both trained and used locally at the respective computing system(s) 22, 70. As another example, in some embodiments, the computing system 70 is not connected to external computing systems, like computing device 92.

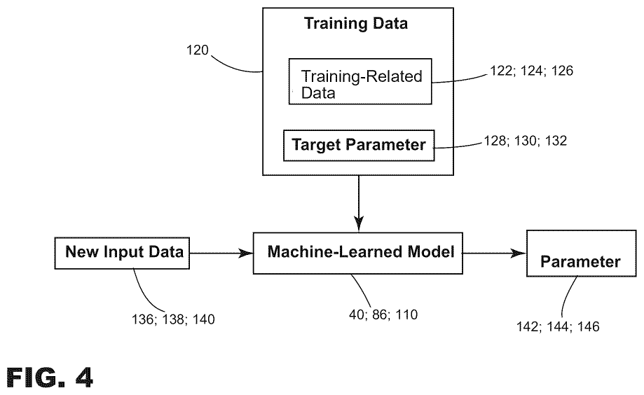

Referring now to FIG. 4, a schematic view illustrating a flow diagram for training a machine-learned model, such as the machine-learned models 40, 86, 110 described above, is illustrated in accordance with aspects of the present subject matter. As indicated above, the model(s) 40, 86, 110 can be trained by a model trainer 118 that uses training data 120 and performs any suitable supervised and/or unsupervised training techniques. In several embodiments, as shown in FIG. 4, the model(s) 40, 86, 110 may be trained using one or more training-related datasets 122; 124; 126, each training-related dataset being associated with one or more respective, known target parameters 128; 130; 132. For instance, the model 40 may be trained using the training-related dataset 122 which is associated with a known value for the target parameter 128 (e.g., robot 14 to be charged). Similarly, the model 86 may be trained using the training-related dataset 124 which is associated with a known value for the target parameter 130 (i.e., the charging parameter). The model 110 may similarly be trained using the training-related dataset 126 that is associated with a known value for the target parameter 132 (e.g., one or more of the target parameters for model(s) 40, 86). For instance, the training-related dataset(s) 122; 124; 126 associated with the target parameter(s) 128; 130; 132 may be continuously collected, generated, and/or received (e.g., via the charging station(s) 58, the computing system(s) 20, the fleet computing system 22, the computing system 70, and/or the like).

By analyzing the dataset(s) 122; 124; 126 in combination with the known or target parameter(s) 128; 130; 132, suitable correlations may be established between the dataset(s) 122; 124; 126 (including certain subsets of the dataset(s)) and the parameter(s) to develop a machine-learned model 40, 86, 110 that can accurately predict the parameter based on new datasets including the same type of data. For example, in some implementations, suitable correlations may be established between the charging parameter and various operation-related conditions associated with or included within the operating data, such as various sensed, calculated, and/or known parameters, settings, machine configurations, and/or operational statuses associated with the charging stations 58.

As shown in FIG. 4, once the machine-learned model 40, 86, 110 has been trained, one or more new datasets 136; 138; 140 can be input into the respective model to allow the model to predict or determine new parameter values 142; 144; 146 for the target parameter. For instance, upon training the model, the operating data collected, generated, and/or received during a subsequent operation can be input into the model to provide operating data associated with such operation. For instance, the model may be used to predict or determine charging sessions at a given frequency (e.g., the frequency at which a new charging session begins and/or the power load desired during each charging session) to allow such parameters to be continuously monitored as the operation is being conducted. As indicated above, such operating data may then be used by the charging system 50 to determine one or more charging parameters for each charging station 58, to generate a charge/discharge command of the battery energy storage system 56, and/or to execute any other suitable control actions.

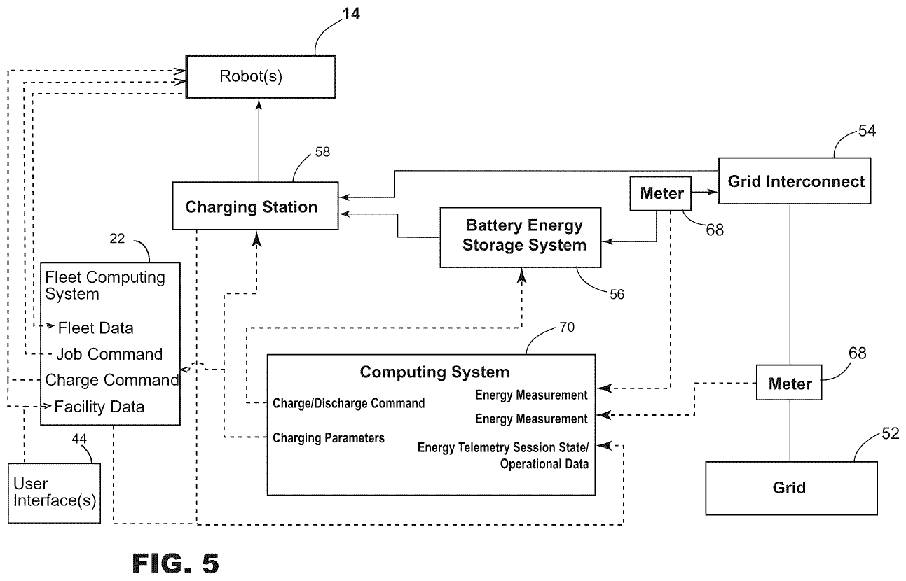

Referring now to FIG. 5, a schematic diagram of communications of the system of FIG. 1 is illustrated in accordance with aspects of the present disclosure. As provided herein, the fleet computing system 22 may be configured to receive jobs to be performed by robots 14 at facility 16. For instance, the fleet computing system 22 may receive inputs indicative of job tasks from the user interface(s) 44 and store such inputs as part of facility data. The fleet computing system 22 may receive or otherwise have access to fleet data. For instance, the fleet of robots 14 may be configured to communicate with the fleet computing system 22 and transmit to the fleet computing system 22 a status profile and a configuration profile for each robot 14. However, the fleet computing system 22 may receive or otherwise have access to fleet data from any other source (e.g., from user interface(s) 44).

The fleet computing system 22 may be configured to generate a job command for one or more of the robots 14 based on the fleet data and the facility data. For instance, the fleet computing system 22 may select an appropriate robot 14 from the fleet 12 for each job request in the facility data based at least in part on the current statuses and configurations of the robots 14 in the fleet 12, and send a command instruction to the selected robot 14 that causes the selected robot to automatically perform the specified job operation. In some instances, a job may be divided across multiple robots 14 and/or the fleet computing system 22 by the fleet computing system 22. For instance, if a job will require a large computational load (e.g., a computational load that is greater than a load threshold) and/or a large power load (e.g., a power load that is greater than a load threshold), the fleet computing system 22 may divide the load across multiple fleet components. Similarly, the fleet computing system 22 may be configured to generate a charge command for one or more robots 14 based on the fleet data and the facility data that causes the robot(s) 14 to charge at the charging station(s) 58. For instance, if a current level of charge of a robot 14 is less than a threshold level of charge, the fleet computing system 22 may determine that the robot 14 needs to charge. In some instances, the robots 14 of a fleet have a higher level of autonomy, and thus, may be able to identify tasks (e.g., from tasks received at the fleet computing system 22 and/or at the robot 14 from a user(s), from evaluating surroundings, and/or the like) and complete tasks autonomously.

As described above, in some instances, the fleet computing system 22 may determine one or both of the job commands and/or the charge commands based at least in part on the charging system 50. For instance, the charging system 50 includes the grid 52 and/or the battery energy storage system 56 which may provide electrical energy to the charging station(s) 58. As shown, a first meter 68 may be positioned between the grid 52 and the grid interconnect 54 to measure the amount of electrical energy that is provided to the grid interconnect 54. Additionally, or alternatively, a second meter 68 may be positioned between the grid interconnect 54 and the battery energy storage system 56 to measure an amount of electrical energy that is transferred from the grid interconnect 54 to the battery energy storage system 56 and/or from the battery energy storage system 56 to the grid interconnect 54. The data indicative of the energy measurements generated by the meters 68 may be provided to the site computing system 70. In addition, each charging station 58 may provide operation data, such as energy telemetry session state data to the computing system 70. Additionally, or alternatively, the fleet computing system 22 may provide data to the site computing system 70, such as the state of charge of the robots 14, assigned tasks (e.g., job and/or charging), future tasks (e.g., not-yet-assigned jobs, predicted jobs, predicted charging, and/or the like), historical tasks (e.g., completed jobs, power load associated with the completed jobs, completed charging time, completed charging load), and/or the like.

Based on the received inputs, the computing system 70 may generate one or more outputs. For example, the inputs may be leveraged by a data analytics model to generate a predicted robot flow and/or a predicted power load during a defined period (e.g., which may be a future period). In such instances, the computing system 70 may determine an energy source for each charging station 58 based on the predicted robot flow. For instance, when an increase in traffic is likely to occur based on the model, the charging station 58 may generally rely on energy from the grid 52. Conversely, when a decrease in traffic is likely to occur based on the model (e.g., model 86), the charging station 58 may rely on energy from the battery energy storage system 56. It will be appreciated that an upcoming increase or decrease in traffic may have any other impact on the charging parameters without departing from the scope of the present disclosure.

The computing system 70 may additionally, or alternatively, leverage a peak shaving estimation model to produce a peak shave target for the battery energy storage system 56. The peak shave target may be consumed by the battery, which can algorithmically determine whether to charge or discharge and at what power to achieve peak shave performance. In some instances, when used in conjunction with the predicted robot flow, which may be a contributor to generating transient loads seen in a load profile of the charging system 50, the charging system 50 can provide a stronger, more sensitive prediction of peak loads and, therefore, can allow a more aggressive peak shave target, ultimately resulting in increased economic benefit to the customer. As such, the model may generate instructions for the charging system 50 that can include a charge/discharge command from the battery energy storage system 56 and/or charging parameters for each charging station 58 according to the peak shave target.

In some instances, the peak shaving estimation model may additionally, or alternatively produce instructions for reducing requested load of the charging system 50. For example, in some instances, the output of the peak shaving estimation model may include generating recommended charging priority windows which may be provided to the fleet computing system 22 such that the fleet computing system 22 may adjust control of the fleet 12 for job and/or charging assignment. For instance, the model may recommend or command a higher priority charging window to the fleet 12 when peak shaving is less necessary (e.g., when cost is lower and/or power supply from the grid is higher), a lower priority charging window when peak shaving is more necessary (e.g., when the cost is higher, power supply from the grid is lower, and/or a state of charge of the battery energy storage system 56 is low), and/or the like. Such charging priority windows may be provided as a charging parameter to the fleet computing system 22, and/or the like. As such, the charging system 50 may proactively help to adjust behavior of the fleet 12 instead of just reacting to predicted demands of the fleet 12.

Additionally, or alternatively, the computing system 70 may leverage a closed-loop control model that seeks to operate the battery energy storage system 56 and issue power limits to the charging stations 58 with active sessions to maintain a power load from the grid interconnect 54 below a defined power value. For example, in some instances, four robots 14 may each request one unit of energy from the charging station 58. However, the defined power value of the interconnect 54 for energy from the grid 52 may be limited to two units of energy. In such instances, the computing system 70 may instruct the battery energy storage system 56 to provide an additional two units of energy so that the robots 14 may be efficiently charged while maintaining the units of energy at or below the defined power value at the interconnect 54. As such, the control model may generate instructions for the charging system 50 that can include a charge/discharge command from the battery energy storage system 56 and/or charging parameters for each charging station 58.

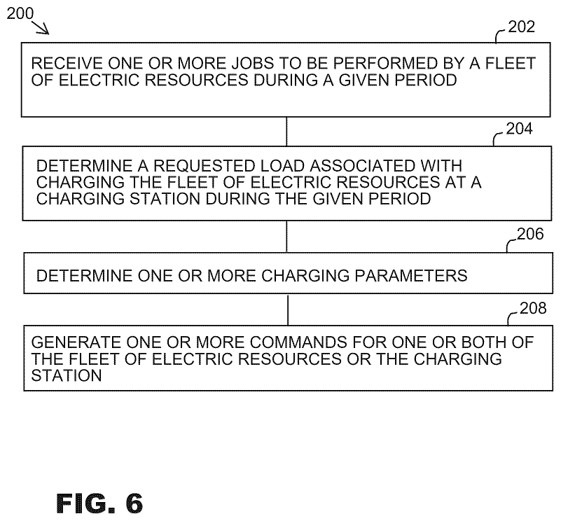

Referring now to FIG. 6, a method 200 for charging a fleet of electric resources is illustrated in accordance with aspects of the present subject matter. In general, the method 200 will be described herein with reference to the system 10 for charging the fleet 12 of robots 14 at a facility 16 using the charging system 50 as described above with reference to FIGS. 1-5. However, the disclosed method 200 may generally be utilized with any suitable charging system. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated in FIG. 6, at (202), the method 200 can include receiving one or more jobs to be performed by a fleet of electric resources during a given period. For instance, the one or more jobs may be input by a user via the user interface(s) 44 of the fleet computing system 22 and/or via the one or more of the electric resources (e.g., robots 14), and/or may be autonomously generated by the electric resources (e.g., robot(s) 14) based on sensor data and/or the like. In some instances, the job(s) may include current jobs and/or predicted jobs. For instance, in some instances, the job(s) may include predicted jobs based on historical job data.

At (204), the method 200 can include determining a requested load associated with charging the fleet of electric resources during the given period. For instance, based on the state of charge of a battery of each resource (e.g., robot 14) of the fleet of electric resources and the one or more jobs to be performed, an estimated amount of additional energy (charge) needed to perform the jobs may be determined. It should be appreciated that such determination may take into account minimum battery charge requirements for each of the robots 14, historical usage data (e.g., for performing tasks associated with jobs, and/or the like), the number and/or configuration of robots 14 in the fleet coupled with the charging system 50, the total power needs of the robots 14 in total, and/or the like. The requested load would be provided by the charging system 50, such as from a power source (e.g., grid 52) and/or stored energy (e.g., the battery energy storage system 56) via a charging station (e.g., charging station(s) 58).

At (206), the method 200 can include determining one or more charging parameters. For instance, the charging parameter(s) may be determined based at least in part on the requested load and at least one of a defined value for the grid 52 or a charge level of the battery energy storage system 56 during the given period. The defined value for the grid may include the current cost per energy unit of energy from the grid 52 and/or the power supply (e.g., amount and/or rate) from the grid 52. In some instances, the one or more parameters may include a peak shave target for the battery energy storage system based on a peak shaving estimation algorithm. As provided herein, the peak shaving algorithm may determine whether to charge or discharge the battery energy storage system 56, what power load to achieve a desired peak shave performance, and/or a charging window priority level.

At (208), the method 200 can include generating one or more commands for one or both of the fleet of electric resources or the charging station. For instance, the commands may be based at least in part on the one or more charging parameters. In some instances, the commands may include charging commands and/or job task commands for the electric resources to proactively adjust the requested load on the charging system 50 by the fleet. In one or more instances, the commands may include commands for the battery energy storage system to provide a power load based on the one or more charging parameters further includes providing an additional amount of power to supplement power provided by the grid (e.g., to maintain the power load of the grid below a threshold, to reduce costs, and/or the like).

In various examples, the method 200 may implement machine learning methods and algorithms that utilize one or several robot learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update an amount of movement of the actuators. In some instances, the robot learning engine may allow for changes to the actuators to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for charging electric resources, the system comprising:
a fleet of electric resources, each resource of the fleet of electric resources having a battery;
a charging station, each resource of the fleet of electric resources being selectively coupled to the charging station for charging, the charging station being configured to supply power from at least one of a grid or a battery energy storage system during charging;
a computing system including a processor and associated memory, the memory storing instructions that, when implemented by the processor, configure the computing system to:
receive one or more jobs to be performed by the fleet during a given period;
determine a requested load associated with charging the fleet of electric resources during the given period based at least in part on a state of charge of the battery of each resource of the fleet of electric resources and the one or more jobs to be performed;
determine one or more charging parameters based at least in part on the requested load and at least one of a defined value for the grid or a charge level of the battery energy storage system during the given period; and
generate one or more commands for one or both of the fleet of electric resources or the charging station based at least in part on the one or more charging parameters.

2. The system of claim 1, wherein the defined value for the grid comprises at least one of a defined supply power or a rate cost.

3. The system of claim 1, wherein the one or more charging parameters comprises either a higher priority charging window or a lower priority charging window.

4. The system of claim 3, wherein the one or more commands comprises more charge commands than job commands when the one or more charging parameters comprises the higher priority charging window, the charge commands being associated with charging one or more resources of the fleet of resources, the job commands being associated with performing tasks associated with the jobs via the one or more of the resources of the fleet of resources, and
wherein the one or more commands comprises more of the job commands than the charge commands when the one or more charging parameters comprises the lower priority charging window.

5. The system of claim 3, wherein the one or more commands comprises reducing functions of one or more of the fleet of resources when the one or more charging parameters comprises the lower priority charging window and the one or more of the fleet of resources is below a minimum charge threshold.

6. The system of claim 1, wherein the one or more charging parameters are at least partially based on a peak shaving estimation algorithm that produces a peak shave target for the battery energy storage system.

7. The system of claim 1, wherein the one or more commands comprises a power limit command for the charging station, the charging station being configured to provide power from the battery energy storage system when charging according to the power limit command to maintain a power load from the grid below a grid power limit.

8. The system of claim 1, wherein the defined value of the grid comprises a supply power of the grid,
the system further comprising:
a first meter configured to measure the supply power of the grid; and
a second meter configured to measure the supply power of the battery energy storage system.

9. The system of claim 1, wherein the computing system is configured to use a machine-learned model to determine the one or more charging parameters.

10. The system of claim 1, wherein the computing system comprises:
a fleet computing system in communication with each resource of the fleet of electric resources; and
a site computing system in communication with the fleet computing system, the charging station, and the battery energy storage system,
wherein the site computing system is configured to determine the one or more charging parameters, and
wherein the one or more commands for the one or both of the fleet of electric resources or the charging station comprises at least one of:
fleet commands generated by the fleet computing system, each of the fleet commands being associated with instructing one or more of the fleet of resources to perform tasks associated with the jobs or charging; or
charging system commands generated by the site computing system, the charging system commands being associated with instructing one or more of the charging station or the battery energy storage system.

11. The system of claim 10, wherein the fleet commands includes a split command associated with instructing the one or more of the fleet of resources to perform tasks associated with the jobs together with at least one of the fleet computing system or another of the fleet of resources.

12. The system of claim 1, wherein the charging station is coupled to the grid and the battery energy storage system in parallel.

13. The system of claim 1, wherein each resource of the fleet of electric resources is a robot.

14. A method for charging electric resources, the method comprising:
receiving one or more jobs to be performed by a fleet of electric resources during a given period, each resource of the fleet of electric resources having a battery;
determining a requested load associated with charging the fleet of electric resources at a charging station during the given period based at least in part on a state of charge of the battery of each resource of the fleet of electric resources and the one or more jobs to be performed, each resource of the fleet of electric resources being selectively coupled to the charging station for charging, the charging station being configured to supply power from at least one of a grid or a battery energy storage system during charging;
determining one or more charging parameters based at least in part on the requested load and at least one of a defined value for the grid or a charge level of the battery energy storage system during the given period; and
generating one or more commands for one or both of the fleet of electric resources or the charging station based at least in part on the one or more charging parameters.

15. The method of claim 14, wherein the defined value for the grid comprises at least one of a defined supply power or a rate cost.

16. The method of claim 14, wherein determining the one or more charging parameters comprises determining either a higher priority charging window or a lower priority charging window.

17. The method of claim 16, wherein generating the one or more commands comprises generating:
more charge commands than job commands when the one or more charging parameters comprises the higher priority charging window, the charge commands being associated with charging one or more resources of the fleet of resources, the job commands being associated with performing tasks associated with the jobs via the one or more of the resources of the fleet of resources, and
more of the job commands than the charge commands when the one or more charging parameters comprises the lower priority charging window.

18. The method of claim 14, wherein determining the one or more charging parameters comprises determining the one or more charging parameters at least partially based on a peak shaving estimation algorithm that produces a peak shave target for the battery energy storage system.

19. The method of claim 14, wherein generating the one or more commands comprises generating a power limit command for the charging station, the charging station being configured to provide power from the battery energy storage system when charging according to the power limit command to maintain a power load from the grid below a grid power limit.

20. The method of claim 14, wherein determining the one or more charging parameters comprises determining the one or more charging parameters at least partially based on a machine-learned model.
